(19) United States
(12) Patent Application Publication
(10) Pub. No.: US 2008/0022755 A1
(43) Pub. Date: Jan. 31, 2008

(54) Gas Detection Method and Gas Sensor

(75) Inventors: Kazunari Shinbo, Niigata-shi (JP); Futao Kaneko, Niigata-shi (JP); Keizo Kato, Niigata-shi (JP); Yasuo Ohdaira, Niigata-shi (JP); Takahiro Kawakami, Niigata-shi (JP); Masahiro Minagawa, Niigata-shi (JP)

Correspondence Address: DARBY & DARBY (formerly Sacco & Associates), P.O. BOX 770, CHURCH STREET STATION, NEW YORK, NY, 10008-0770, US

(73) Assignees: Weidmann Plastics Technology AG, Rapperswil (CH); NIIGATA UNIVERSITY, NIIGATA-SHI (JP)

(21) Appl. No.: 11/632,243

(22) PCT Filed: Jul. 12, 2005
(86) PCT No.: PCT/JP05/12817

§ 371 Date: Jan. 11, 2007

(30) Foreign Application Priority Data
Jul. 12, 2004 (JP) 2004-205168

(51) Int. Cl. G01N 27/00; G01N 27/12

(52) U.S. Cl. 73/31.06

(57) ABSTRACT

The invention provides a gas detection method and a gas sensor which utilize an amount of change in the electrical characteristic of a gas sensitive thin film with respect to the adsorption amount of a gas to be detected. The gas sensitive thin film (7) having characteristic detection electrodes (5, 6) functioning as a sandwich electrode or a gap electrode is laid out on a crystal resonator (10), and change in the electrical characteristic of the gas sensitive thin film (7) with respect to the adsorption amount of the detection target gas is observed by simultaneously determining change in the oscillatory frequency of the crystal resonator (10) and the electrical characteristic of the gas sensitive thin film (7). Because the sensor is an integral type device, both changes in an adsorption mass and the electrical characteristic can be surely monitored.

### TECHNICAL FIELD

The present invention relates to a gas detection method and a gas sensor which use a crystal resonator.

### BACKGROUND ART

As disclosed in Patent Literature 1, there is conventionally known a gas sensor which utilizes change in the electrical characteristic of a gas sensitive thin film (composed of an oxidative product in Patent Literature 1), such as resistivity change, generation of electromotive force, and a capacitance inherent to adsorption of a gas to be determined.

As disclosed in Patent Literature 2, there is also known a sensor which utilizes reduction of the oscillatory frequency of a crystal resonator or decrement of the resistivity of a gas sensitive film in accordance with an NO₂ gas adsorbed on the gas sensitive film, thereby detecting a tiny amount of NO₂ gas.

Further, as disclosed in Patent Literature 3, there is known a sensor which utilizes change in light absorption of a gas sensitive film in accordance with a hydrogen gas adsorbed on the gas sensitive film, detecting a tiny amount of hydrogen gas.

In addition, there are proposed a crystal-resonator-microbalance type gas sensor having an organic semiconductor, on which a gas to be detected adsorbs, coated on the surface of the sensor, and a mass-detection type gas sensor which uses an SAW device.

Still further, there is proposed an electrical characteristic detection type gas sensor which uses an organic semiconductor. As such a gas sensor, not only a gap electrode type gas sensor (see, Patent Literature 2), but also a sandwich type gas sensor (see, Non Patent Literature 1) and a sensor formed in a thin-film-transistor-like shape are reported.

There is proposed a method of forming those mass measurement device and electrical characteristic measurement device separately, and performing measurements simultaneously, thereby measuring composite change in the electrical characteristic with respect to an amount of an adsorbed gas (see, Non Patent Literature 3).

On the other hand, there is proposed a method of forming a device for electrical characteristic measurement on a device for mass measurement in Patent Literature 4. Patent Literature 1: Japanese Unexamined Patent Publication No. H11-101763. Patent Literature 2: Japanese Unexamined Patent Publication No. H7-43285. Patent Literature 3: Japanese Unexamined Patent Publication No. 2003-329592. Patent Literature 4: Japanese Patent Publication No. H11-507729. Non Patent Literature 1: “Colloids and Surfaces A: Physicochemical and Engineering Aspects” (Holland), Elsevier Science B.V., 2002, No. 198 to 200, P. 905 to 909. Non Patent Literature 2: “Sensors and Actuators B” (Holland), Elsevier Science B.V., 2002, No. 67, P. 312 to 316. Non Patent Literature 3: “Analytical Chemistry” (U.S.), American Chemical Society, Sep. 15, 2001, Vol. 73, No. 18, P. 4441 to 4449.

### DISCLOSURE OF THE INVENTION

Problem to be Solved by the Invention

According to the conventional gas sensor disclosed in Patent Literature 1, however, there is a problem such that how much a substance to be detected adsorbs on a device to bring about change in the electrical characteristic cannot be directly known.

The conventional gas sensor disclosed in Patent Literature 2 detects a tiny amount of gas adsorbed on the gas sensitive thin film, and can detect a tiny amount of adsorbed gas from the resistivity of the gas sensitive thin film having a comb-like shape electrode by utilizing the property of the crystal resonator, so called QCM (Quartz Crystal Microbalance), but there is a problem such that how much a substance to be detected adsorbs on a device to bring about change in the electrical characteristic cannot be directly known from each device.

The conventional gas sensor disclosed in Patent Literature 3 has a problem such that how much a substance to be detected adsorbs on a device to bring about change in the light absorption characteristic cannot be directly known.

In addition, in a case where the devices for mass measurement and for electrical characteristic measurement are separately formed, it is difficult to perform pinpoint measurement accurately because measurement points differ. Further, forming organic thin films having the same surface shape and thickness with good reproducibility is generally difficult, and accordingly, an adsorption amount and an adsorption speed with respect to an organic film on the mass measurement device and the electrical characteristic measurement device differ, resulting in occurrence of an error. The response of gas adsorption cannot be controlled.

Further, the conventional gas sensor disclosed in Patent Publication 4 merely measures a conductivity with respect to only an electrode bridged by an organic polymer thin film. Accordingly, there is a problem such that information on the mobility cannot be obtained. Because the device is gap type, driving voltage becomes large when a high resistance semiconductor is used.

The present invention has been made in view of the foregoing problems, and it is an object of the invention to provide a gas detection method and a gas sensor which use a crystal resonator or a surface acoustic wave device, and can accurately detect an amount of change in the adsorption mass of a gas to be detected and an amount of change in an electrical characteristic or an optical-electrical characteristic inherent to the change in the adsorption mass.

Means for Solving the Problem

According to a gas detection method and a gas sensor of the invention, a gas adsorber, which has a gas sensitive film that changes an electrical characteristic thereof in accordance with an adsorption amount of a gas to be detected, and characteristic detection electrodes for detecting the electrical characteristic, all stacked each other, are laid out on a crystal resonator or a surface acoustic wave device, one of the characteristic detection electrodes located at a top layer is structured in such a way that the gas to be detected can pass through, and an electrical characteristic between the characteristic detection electrodes and an adsorption mass through the crystal resonator or the surface acoustic wave device are detected.

This facilitates detection and discrimination of a detection target gas by observing the electrical characteristic between the characteristic detection electrodes and the adsorption mass using changes in the electrical characteristic of the gas sensitive film and the adsorption mass detected by the crystal resonator or the surface acoustic wave device inherent to adsorption of the detection target gas on the gas sensitive film. Because all structural components are formed in such a manner as to be stacked and formed in layer-like shapes, the structure becomes simple, and a process like etching becomes unnecessary. Therefore, the gas sensor can be inexpensively fabricated. Further, because one characteristic detection electrode located at the top layer is structured in such a way that the detection target gas can pass through, a contact area of the gas sensitive film and the detection target gas can be secured, and the detection target gas can be detected well even though the top face of the gas sensitive film is covered with the characteristic detection electrode.

An insulating film which insulates a crystal-oscillation electrode constituting the crystal resonator and the characteristic detection electrode from each other is provided between the crystal resonator and the gas adsorber.

This prevents a current from flowing through between the crystal-oscillation electrode and the characteristic detection electrode, and even if the electrical characteristic between the characteristic detection electrodes and the oscillatory characteristic of the crystal resonator are simultaneously observed, those observations do not mutually affect.

A semiconductor device which has a source electrode, a drain electrode, a gas sensitive film made of a semiconductor material that changes an electrical characteristic thereof in accordance with an adsorption amount of a gas to be detected, a gate electrode, and a gate insulating film that insulates the gate electrode, the source electrode, and the drain electrode from one another is laid out on a crystal resonator or a surface acoustic wave device, and an electrical characteristic between a source and a drain and an adsorption mass through the crystal resonator or the surface acoustic wave device are detected while applying a voltage to the gate electrode.

This causes a current (drain current) which flows through between the source and the drain to increase largely by applying a voltage to the gate electrode to form a channel in the gas sensitive film. As the current changes along with gas adsorption, adsorption of the detection target gas can be observed.

A gas adsorber which has a gas sensitive film that changes an electrical characteristic thereof in accordance with an adsorption amount of a gas to be detected, and characteristic detection electrodes that abut with a piezoelectric body constituting a crystal resonator or a surface acoustic wave device are laid out on the crystal resonator or the surface acoustic wave device, and an electrical characteristic between the characteristic detection electrodes, and an adsorption mass through the crystal resonator or the surface acoustic wave device are detected.

The characteristic detection electrode is so provided as to abut with the piezoelectric body, the characteristic electrode and one crystal-oscillation electrode are located in the same layer, enabling thinning, and the electrical characteristic of the gas sensitive film can be determined using the characteristic detection electrode. Further, if the gas sensitive film deforms due to gas adsorption, electromotive force generated when stress is applied to the piezoelectric body due to deformation can be measured.

A gas adsorber which has a gas sensitive film that changes an optical-electrical characteristic in accordance with an adsorption amount of a gas to be detected, and characteristic detection electrodes for detecting the electrical characteristic are laid out on a crystal resonator or a surface acoustic wave device, and a light absorption, reflection, or fluorescent characteristic of the gas sensitive film and an electrical characteristic between the characteristic detection electrodes, and, an adsorption mass through the crystal resonator or the surface acoustic wave device are observed.

This facilitates detection and discrimination of a detection target gas by observing the optical-electrical characteristic between the characteristic detection electrodes and the adsorption mass utilizing changes in the optical characteristic and the electrical characteristic of the gas sensitive film and the detected adsorption mass by the crystal resonator or the surface acoustic wave device inherent to adsorption of the detection target gas on the gas sensitive film.

### EFFECTS OF THE INVENTION

The gas detection method and the gas sensor of the invention has a gas sensitive film, which has a characteristic detection electrode, disposed on a crystal resonator or a surface acoustic wave device, and can detect the adsorption mass of a substance through the crystal resonator or the surface acoustic wave device, and an amount of change in an electrical characteristic with respect to the adsorption mass can be observed by one device.

In comparison with a case where observation is performed with a crystal resonator or a surface acoustic wave device and a device sandwiching a gas sensitive film formed separately from each other, the foregoing method can detect an amount of change in an adsorption mass and an amount of change in an electrical characteristic accurately.

By observing relationships between an adsorption mass and change in the electrical physical property of a sensitive material for some gases to be detected beforehand, it is possible to do discrimination for gases which have different molecular masses and bring about the same electrical-physical-property change per adsorption molecularity.

As a gas sensitive film which changes the optical characteristic and the electrical characteristic thereof in accordance with the adsorption amount of a gas to be detected is used, the optical absorption, reflection, or fluorescent characteristic and the electrical characteristic of a device and a gas adsorption mass can be observed simultaneously, so that gas discrimination performance can be improved.

### BRIEF DESCRIPTION OF DRAWING

FIG. 1 is a vertical cross-sectional view illustrating the structure of a gas sensor according to a first embodiment of the invention;

FIG. 2 is a vertical cross-sectional view illustrating the structure of a gas sensor according to a second embodiment of the invention;

FIG. 3 is a vertical cross-sectional view illustrating the structure of a gas sensor according to a third embodiment of the invention;

FIG. 4 is a vertical cross-sectional view illustrating the structure of a gas sensor according to a fourth embodiment of the invention; and

FIG. 5 is a perspective view illustrating the structure of the gas sensor of the fourth embodiment.

### BEST MODE FOR CARRYING OUT THE INVENTION

Each of the preferred embodiments of a gas determination method and a gas sensor using that determination method of the invention will be explained with reference to the accompanying drawings. The same portions will be denoted by the same reference numbers in each of the embodiments to omit redundant explanations for common parts as much as possible.

According to the invention, a gas sensitive thin film having a gap electrode or a sandwich electrode is laid out on a crystal resonator or a surface acoustic wave device, and the oscillatory characteristic of the crystal resonator or the propagation characteristic of a surface acoustic wave in the surface acoustic wave device and the electrical characteristic of the gas sensitive thin film having the gap electrode or the sandwich electrode, and further, the optical characteristic of the gas sensitive thin film are simultaneously observed.

### First Embodiment

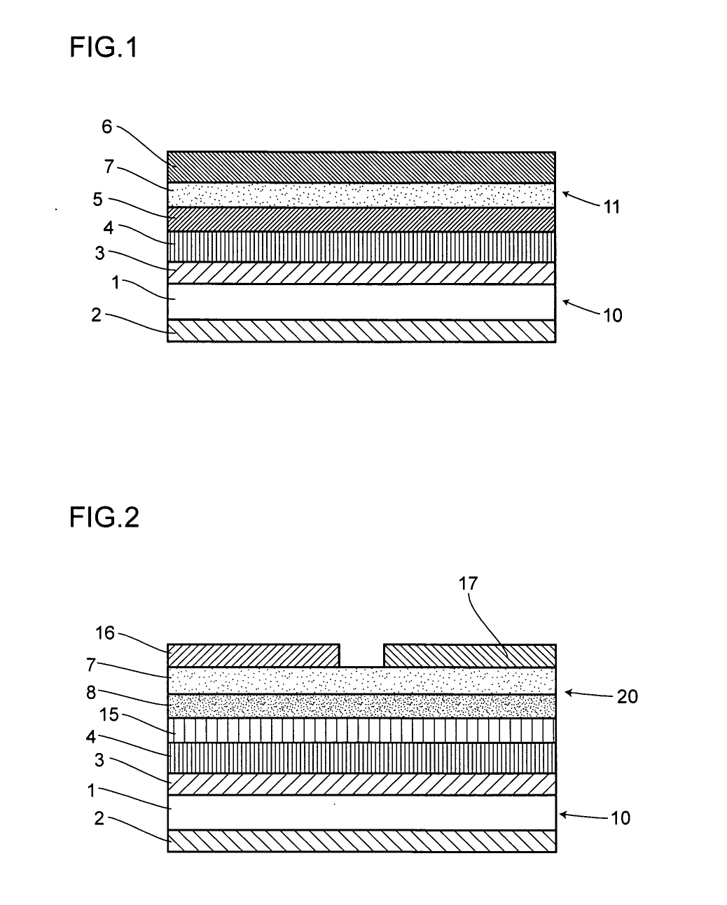

FIG. 1 illustrates an example of the layout of a gas sensor according to the embodiment, and the gas sensor comprises a crystal resonator 10 having a crystal 1 and a pair of crystal-oscillation electrodes 2, 3, an insulating film 4 on the crystal-oscillation electrode 3, and a gas adsorber 11 having a pair of characteristic detection electrodes 5, 6 laid out on the insulating film 4, and a gas sensitive thin film 7. The crystal-oscillation electrode 3 and the characteristic detection electrode 5 are insulated from each other by the insulating film 4. Note that the materials of the crystal-oscillation electrodes 2, 3, and the characteristic detection electrodes 5, 6 may be the same or different kinds in the gas sensor device. The crystal-oscillation electrode 3 and the characteristic detection electrode 5 may be integral without the insulating film 4.

Like the crystal resonator 10, the gas adsorber 11 has the characteristic detection electrodes 5, 6 provided in such a manner as to sandwich the gas sensitive thin film 7 in the vertical direction, and laid out as to form a sandwich electrode. Forming the gas adsorber 11 as a sandwich device facilitates reduction of a distance between the electrodes, thereby reducing the driving voltage. As the area of the electrode becomes large, it is easy to cause a large current to flow. It is necessary that the characteristic detection electrode 6 located at the top layer should be formed in a mesh-like shape to allow the gas to be detected to pass through. This secures a contact area of the gas sensitive thin film 7 and the gas to be detected, so that even though the top face of the gas sensitive thin film 7 is covered with the characteristic detection electrode 6, it is possible to detect the gas to be detected well.

The gas sensitive thin film 7 is formed of an organic semiconductor like phthalocyanine, an oxide semiconductor, such as SnO₂ (tin oxide) or ZnO (zinc oxide), or an organic-inorganic complex thin film, and changes the electrical characteristic thereof by adsorbing a gas. The electrical characteristic means various electrical characteristics, such as a current-voltage characteristic, a resistance, electromotive force, and a capacitance, and an electrical characteristic to be changed is decided by a material and combination of materials used for the gas sensitive thin film 7. For example, in a case where SnO₂ is used for the gas sensitive thin film 7, when an oxidative gas which takes electrons adsorbs on the surface of the gas sensitive thin film 7, the resistance becomes large, and when a reductive gas which gives electrons adsorbs on the surface of the gas sensitive thin film 7, the resistance becomes small. In a case where phthalocyanine is used for the gas sensitive thin film 7, when an oxidative gas which takes electrons adsorbs on the surface of the gas sensitive thin film 7, the resistance becomes small, and when a reductive gas which gives electrons adsorbs on the surface of the gas sensitive thin film 7, the resistance becomes large. To obtain a strength, an oxide semiconductor or an organic-inorganic complex thin film may be used for the gas sensitive thin film 7.

When a current is caused to flow through between the characteristic detection electrodes 5, 6, the current flowing through between the characteristic detection electrodes 5, 6 increases or decreases in accordance with change in the resistance of the gas sensitive thin film inherent to adsorption of the gas to be detected, so that the current-voltage characteristic of the gas sensitive thin film 7 can be observed by measuring the current. The electrical characteristics, such as electromotive force, a short current, and a capacitance can be observed through the characteristic detection electrodes 5, 6. In a case of a gas which is ionized after adsorbed by the thin film (e.g., gas molecules undergone electron donation or electron reception with respect to the material of the thin film and to be ionized, like an iodine gas with respect to polyacetylene), ionized gas molecules can be moved by an electrical field applied between the characteristic detection electrodes 5, 6. That is, when the electrode 6 is positively biased with respect to the electrode 5, positive ions can be moved to the electrode 5 side, and negative ions can be moved to the electrode 6 side. When the polarity of the applied electrical field is inverted, the motions of those ions become inverted. This makes it possible to control the distribution of the adsorbed gas molecules inside the thin film. Adsorption on the surface and motion to the inside of the thin film may contribute adsorption phenomenon, but the motion of the adsorbed molecules to the inside of the thin film can be controlled by voltage application. Further, differences in electrical characteristics when a gas is adsorbed near a boundary face of the electrode, for example, and when the adsorbed gas molecules move to the inside of the thin film can be observed. When mobile ions present inside the thin film is moved by voltage and phenomenon like expansion or shrinking which changes the thin film structure occurs, a difference in gas adsorption phenomenon inherent to the change in the thin film structure can be observed. In performing the foregoing observations, because the gas sensor device of the embodiment is an integral type device, both changes in the adsorption mass and the electrical characteristic can be surely monitored. Further, because the gas sensor device is an integral device, even if the organic semiconductor film is covered with an upper electrode in the sandwich device, the adsorption mass can be acquired accurately in comparison with a case where devices are formed separately.

Next, an explanation will be given of the working of the invention.

The gas sensor is exposed to a gas to be detected, and change in the oscillatory frequency of the crystal resonator 10 is observed during that exposure. For example, a current-voltage characteristic, or electrical characteristics, such as electromotive force, a short current, and a capacitance between the electrode 5 and the electrode 6 are simultaneously observed. As the detection target gas adsorbs on the device, i.e., on the surface of the gas sensitive thin film 7, the electrical characteristic of the gas sensitive thin film 7 changes as mentioned above. At this time, the mass of the gas sensor device increases by what corresponds to the adsorption mass of the detection target gas. Because the crystal resonator 10 has a characteristic (QCM) that a unique oscillatory frequency changes in accordance with the mass of a deposition deposited on the surface of the crystal resonator, the frequency decreases as the adsorption mass of the detection target gas increases. That is, the oscillatory frequency of the crystal resonator 10 changes almost in proportion to the mass of the adsorbed detection target gas. Because those electrical characteristic and frequency characteristic indicate unique values in accordance with the adsorption amount and the kind of the detection target gas, detection and discrimination of the detection target gas are performed by comparing relationships between an adsorption mass and electrical physical property change observed beforehand for some gases to be detected. Identification and discrimination of a detection target gas can be performed in this manner from the adsorption amount of the detection target gas, i.e., an amount of change in an electrical characteristic with respect to change in the frequency of the crystal resonator 10. It is possible to change the spatial distribution of ions by a voltage applied between the electrode 5 and the electrode 6, and observe adsorption response at this time.

According to the gas sensor of the invention, the adsorption mass of a substance can be observed from the oscillatory frequency characteristic of the crystal resonator 10 through one gas sensor device, and an amount of change in an electrical characteristic with respect to the adsorption mass can be observed. Accordingly, unlike conventional technologies, it is not necessary to arrange two sensors to use, and pinpoint and accurate detection with respect to a point (a spot) subjected to detection becomes possible.

As the individual structural parts are so formed as to be stacked in layers, the structure becomes simple, so that a process like etching becomes unnecessary. Therefore, the gas sensor can be inexpensively fabricated. Further, as one characteristic detection electrode 6 located at the top layer is formed in such a way that the detection target gas can pass through, the contact area of the gas sensitive thin film 7 and the detection target gas can be secured, so that even if the top face of the gas sensitive thin film 7 is covered with the characteristic detection electrode 6, it is possible to detect the detection target gas well.

The insulating film 4 which insulates the crystal-oscillation electrode 3 and the characteristic detection electrode 5 from each other is provided between the crystal resonator 10 and the gas adsorber 11.

This prevents a current from flowing through between the crystal-oscillation electrode 3 and the characteristic detection electrode 5, so that even if the electrical characteristic between the characteristic detection electrodes 5, 6, and the oscillatory frequency of the crystal resonator 10 are observed simultaneously, observations do not mutually affect to each other.

In the foregoing embodiment, a material which changes the electrical characteristic thereof in accordance with gas adsorption like palladium may be used for the electrode 6 located at the top, and the working in this case is likewise the foregoing embodiment. A structure such that a portion of the crystal-oscillation electrode 3 is removed by etching or the like, and the characteristic detection electrodes 5, 6 and the gas sensitive thin film 7 is stacked one another at that portion may be employed. Further, the crystal resonator 10 for mass measurement may be replaced by a surface acoustic wave device disclosed in Japanese Unexamined Patent Publication No. 2002-350445.

### Second Embodiment

FIG. 2 illustrates an example of the layout of a gas sensor according to the embodiment. That is, a thin film transistor 20 which is a semiconductor device comprising a gate electrode 15, a gate insulating film 8, a source electrode 16, a drain electrode 17, and the gas sensitive thin film 7 is laid out over the crystal resonator 10 comprising the crystal 1 and the crystal-oscillation electrodes 2, 3, and, the insulating film 4. The crystal-oscillation electrode 3 and the gate electrode 15 may be integral without the insulating film 4 in the gas sensor device. It may be possible to employ a structure such that a portion of the crystal-oscillation electrode 3 is removed by etching or the like, and the thin film transistor 20 is formed at that portion.

The thin film transistor 20 is formed in such a way that the gate electrode 15, the gate insulating film 8 which insulate the gate electrode 15, the source electrode 16, and the drain electrode 17 from one another, the source electrode 16, the drain electrode 17, and the gas sensitive thin film 7 are stacked one another. The source electrode 16 and the drain electrode 17 are provided above the gas sensitive thin film 7, but the source electrode 16 and the drain electrode 17 may be laid out under the gas sensitive thin film 7.

When a voltage is applied to the gate electrode 15, electrical charges are charged in the gas sensitive thin film 7 and a channel is formed, so that a portion between the source electrode 16 and the drain electrode 17, i.e., a portion between the source and the drain conducts. When a voltage is applied to the drain electrode 17 to cause a drain current (a current which flows between the drain electrode 17 and the source electrode 16) to flow, a drain current increases or decreases in accordance with change in the resistance of the gas sensitive thin film 7 inherent to adsorption of the detection target gas, and the current-voltage characteristic of the gas sensitive thin film 7 can be observed by measuring the current. Adsorption of the detection target gas can be observed from the current-voltage characteristic of the gas sensitive thin film 7. The effect of the detection target gas on a gas sensitive thin film can be determined by observing changes in the operation of the transistor inherent to gas adsorption, such as a mobility μ which is the characteristic value of the transistor, an on-off ratio of drain currents when a gate voltage is not applied and when the gate electrode is applied, a threshold voltage V_{T} which is a gate voltage to turn on the transistor, and a sub threshold voltage V_{S} which is an amount of change in a gate voltage for increasing a drain current by one digit.

In a case of a gas ionized after adsorbed by the thin film, the molecules of an ionized gas can be moved by an electrical field originating from a gate voltage. That is, when a positive gate voltage is applied, positive ions can be moved to an outside air side, and negative ions can be moved to the insulating film side. When a negative gate electrode is applied, the motions of those ions become inverted. This enables controlling of the distribution of the adsorbed gas molecules in the thin film. Adsorption on the surface and motion to the inside of the thin film may contribute adsorption phenomenon, but the motion of the adsorbed molecules to the inside of the thin film can be controlled by voltage application. Further, differences in transistor characteristics when a gas is adsorbed on the surface of the thin film, for example, and when the adsorbed gas molecules move to the inside of the thin film can be observed. When mobile ions present inside the thin film is moved by an electrical field and phenomenon like expansion or shrinking which changes the thin film structure occurs, a difference in gas adsorption response inherent to the change in the thin film structure can be observed. In those cases, for example, the gas sensor is exposed to the gas while applying a gate voltage, and an FET operation is observed after a predetermined time, thereby checking a difference from a case where a gate voltage is not applied. At this time, as a gas adsorption amount increases, a current value increases, and a capacitance-applied-voltage characteristic is changed due to the electrical charges of the adsorbed gas. In addition, changes relating to the FET operation, such as V_{T}, V_{S}, and μ can be acquired. Of course, change in the gas adsorption amount due to QCM is simultaneously measured, and an effect of application of the gate voltage can be determined. In doing the foregoing determination, because the sensor device is an integral type device, it is possible to surely monitor both changes in the adsorption mass and the electrical characteristic.

The working of the invention in the embodiment is the same as that of the first embodiment except the amplification effect of the thin film transistor 20.

As mentioned above, according to the embodiment, the thin film transistor 20 as a semiconductor device comprising the source electrode 16, the drain electrode 17, the gas sensitive thin film 7 which is formed of a semiconductor material that changes the electrical characteristic thereof in accordance with an adsorption amount of the detection target gas, the gate electrode 15, and the gate insulating film 8 which insulates the gate electrode 15, the source electrode 16, and the drain electrode 17 from one another is laid out on the crystal resonator 10 comprising the crystal 1 which vibrates at a unique frequency, and the crystal-oscillation electrodes 2, 3, and the electrical characteristic between the source and the drain and the oscillatory characteristic of the crystal 1 are observed while applying a voltage to the gate electrode 15.

This causes a current (drain current) which flows through between the source and the drain to increase largely by applying a voltage to the gate electrode 15 to form a channel in the gas sensitive thin film 7. As the drain current changes along with adsorption of the gas, adsorption of the detection target gas can be observed. Distribution of mobile ions in the thin film can be controlled by application of a gate voltage. This makes it possible to determine differences in the transistor operations by controlling the distribution of the ionized adsorbed gas in the thin film, and to control an adsorption speed and an adsorption amount by change in the structure of the thin film inherent to movement of the mobile ions. Note that the crystal resonator 10 for performing mass measurement may be replaced by the foregoing surface acoustic wave device.

### Third Embodiment

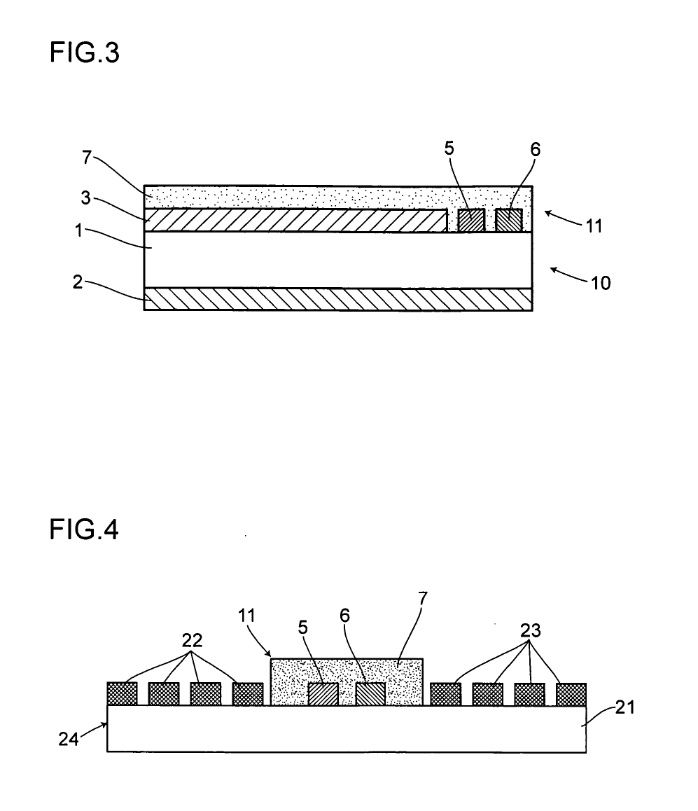

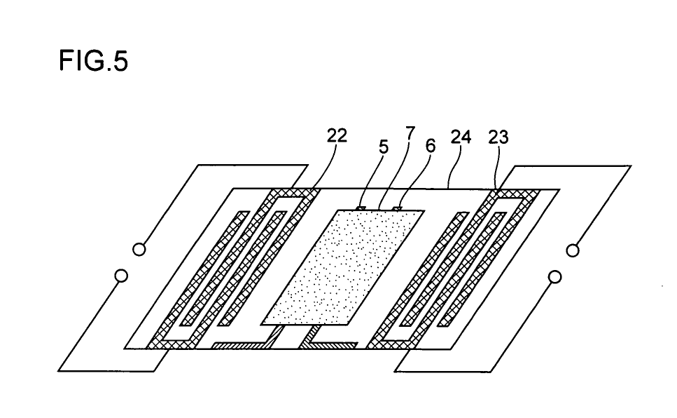

FIG. 3 illustrates an example of the layout of a gas sensor according to the embodiment, and the gas sensor comprises the crystal resonator 10 having the crystal 1 and the pair of crystal-oscillation electrodes 2, 3, and the gas adsorber 11 having the pair of characteristic detection electrodes 5, 6, and the gas sensitive thin film 7, all laid out at the same layer as the crystal-oscillation electrode 3. Note that the electrode 3 and the electrode 5 may be integral with each other.

The crystal-oscillation electrode 3 and the characteristic detection electrodes 5, 6 are provided below the gas sensitive thin film 7 in such a manner as to be the same layer. Therefore, to form the crystal-oscillation electrode 3 and the characteristic detection electrodes 5, 6, an electrode layer is once formed, and then the individual electrodes are formed by etching. Forming the crystal-oscillation electrode 3 and the characteristic detection electrodes 5, 6 at the same layer enables thinning of the sensor.

When a current is caused to flow through between the characteristic detection electrodes 5, 6, the current which flows through between the characteristic detection electrodes 5, 6 increases or decreases in accordance with change in the resistance of the gas sensitive thin film 7 inherent to adsorption of the detection target gas, and this enables observation of the current-voltage characteristic of the gas sensitive thin film 7 by measuring the current. The electrical characteristics, such as generation of electromotive force, and a capacitance can be observed through the characteristic detection electrodes 5, 6. Further, because a current passes through between the crystal-oscillation electrode 3 and the characteristic detection electrode 5.

3 When pressure is applied to the crystal 1, electromotive force is generated by piezoelectric phenomenon. When the detection target gas adsorbs on the gas sensitive thin film 7, the gas sensitive thin film 7 expands or shrinks, and change in stress is caused, so that the crystal 1 generates electromotive force. In the embodiment, because the characteristic detection electrodes 5, 6 and the crystal-oscillation electrode 2 are provided on the crystal 1, it is possible to measure the electromotive force using the characteristic detection electrodes 5, 6, and the crystal-oscillation electrode 2.

The working of the invention in the embodiment is the same as that of the first embodiment except the crystal-oscillation electrode 3 and the characteristic detection electrodes 5, 6.

As mentioned above, according to the embodiment, the gas adsorber 11 comprising the gas sensitive thin film 7 which changes the electrical characteristics thereof in accordance with an adsorption amount of the detection target gas, and the characteristic detection electrodes 5, 6 which abut with the crystal 1 and detect the foregoing electrical characteristic is laid out on the crystal resonator 10 comprising the crystal 1 which vibrates at a unique frequency, and the crystal-oscillation electrodes 2, 3 for applying a voltage to the crystal 1, and the electrical characteristics of the characteristic detection electrodes 5, 6 and the oscillatory characteristic of the crystal resonator 10 are observed.

In this manner, because the characteristic detection electrodes 5, 6 are so provided as to abut with the crystal 1, the characteristic detection electrodes 5, 6 and the one crystal-oscillation electrode 3 are located in the same layer, thereby enabling thinning of the sensor, and electromotive force generated by the crystal 1 can be measured using the characteristic detection electrodes 5, 6 and the crystal-oscillation electrode 2, in addition to the electrical characteristic of the gas sensitive thin film 7. Note that the crystal resonator 10 for mass measurement may be replaced by the foregoing surface acoustic wave device.

### Fourth Embodiment

FIG. 4 illustrates an example of the layout of a gas sensor according to the embodiment, and the gas sensor comprises a surface acoustic wave device 24 having a piezoelectric body 21, a comb-like exciting electrode 22, and a comb-like reception electrode 23, and, the gas adsorber 11 having the pair of characteristic detection electrodes 5, 6 and the gas sensitive thin film 7, all laid out in the same layer as the exciting electrode 22. The operation of the surface acoustic wave device 24 is substantially the same as one disclosed in Japanese Unexamined Patent Publication No. 2002-35044. Change in the propagation characteristic of a surface acoustic wave based on adsorption of a substance is detected from a signal generated at the comb-like reception electrode 23. In general, an external circuit is connected to constitute an oscillating circuit, and an oscillatory characteristic is determined. A crystal resonator may be used as mass measuring means, instead of the surface acoustic wave device 24. A material which changes both optical characteristic and electrical characteristic thereof (optical-electrical characteristic) inherent to gas adsorption is used for the gas sensitive thin film 7. The optical characteristic in this case means optical adsorption, reflection, scattering, or fluorescent characteristic. Transparent or semi-transparent materials can be used for the crystal-oscillation electrode as the exciting and reception electrode and the characteristic detection electrodes 5, 6.

When a current is caused to flow through between the characteristic detection electrodes 5, 6, the current which flows through between the characteristic detection electrodes 5, 6 increases or decreases in accordance with change in the resistance of the gas sensitive thin film inherent to adsorption of the detection target gas, so that the current-voltage characteristic of the gas sensitive thin film 7 can be observed by measuring the current. Electrical characteristics, such as generation of electromotive force, and a capacitance can be observed through the characteristic detection electrodes 5, 6. Further, providing a photo detector (not illustrated) makes it possible to observe the optical adsorption, reflection, scattering, or fluorescent characteristic of the gas sensitive thin film inherent to adsorption of the detection target gas. Simultaneously, an adsorption amount of gas is observed through the surface acoustic wave device 24.

In the embodiment, the optical adsorption, reflection, scattering, or fluorescent characteristic of the gas sensitive thin film 7 is observed in addition to changes in the mass and the electrical characteristic while the gas sensor device is exposed to the detection target gas. Because the optical characteristic, the electrical characteristic and the mass property of the gas sensitive thin film 7 indicate unique values in accordance with the adsorption amount and kind of the detection target gas, detection and discrimination of the detection target gas are carried out by comparing relationships between an adsorption mass and an optical physical property, an electrical physical property change observed beforehand for some detection target gases.

As mentioned above, according to the embodiment, the gas adsorber 11 comprising the gas sensitive thin film 7 which changes the optical characteristic and the electrical characteristic thereof in accordance with the adsorption amount of a detection target gas, and the characteristic detection electrodes 5, 6 which abut with the piezoelectric body 21 and are for detecting the electrical characteristic is laid out on the surface acoustic wave device 24, and the electrical characteristic between the characteristic detection electrodes 5, 6 and the oscillatory characteristic of the surface acoustic wave device 24 are observed. This facilitates detection and discrimination of a detection target gas from the amount of changes in the optical characteristic and the electrical characteristic both corresponding to change in the adsorption amount of the detection target gas detected by the surface acoustic wave device 24.

The invention is not limited to the foregoing individual embodiments, and can be changed within the scope of the invention. The gas sensitive thin film 7 may be anything which changes the electrical characteristic and the optical characteristic thereof by adsorption of a detection target gas, and the shape of the gas sensitive thin film is not limited to any particular shape. Changing the material of the gas sensitive thin film 7 enables detection of various gases. The electrical characteristic of the gas sensitive thin film 7 having a gap electrode or a sandwich electrode and the optical characteristic of the gas sensitive thin film 7, the oscillatory characteristic of the crystal resonator 10 or the propagation characteristic of a surface acoustic wave in the surface acoustic wave device 24 may be observed alternately, or any one or two of them may be observed.

### INDUSTRIAL APPLICABILITY

Expected applications of the invention are detection and discrimination of an oxidative gas like nitrogen oxide, a basic gas like ammonia, an organic solvent gas, carbon monoxide, and carbon dioxide by selecting the gas sensitive thin film 7. It is further expected that the invention is used for environmental monitoring and process management.

1. (canceled)

2. (canceled)

3. A gas detection method comprising steps of disposing a semiconductor device, which has a source electrode, a drain electrode, a gas sensitive film made of a semiconductor material that changes an electrical characteristic thereof in accordance with an adsorption amount of a gas to be detected, a gate electrode, and a gate insulating film that insulates said gate electrode, said source electrode, and said drain electrode from one another, on a crystal resonator or a surface acoustic wave device, and performing measurement of an electrical characteristic between a source and a drain and measurement of an adsorption mass of said crystal resonator or said surface acoustic wave device while applying a voltage to said gate electrode.

4. (canceled)

5. The gas detection method according to claim 3, wherein said gas sensitive film changes an optical-electrical characteristic in accordance with an adsorption amount of a said detection target gas, and measurements of an optical characteristic of said gas sensitive film and an electrical characteristic between said source and said drain, and, said adsorption mass of said crystal resonator or said surface acoustic wave device are performed.

6. (canceled)

7. (canceled)

8. A gas sensor comprising a crystal resonator or a surface acoustic wave device, and a semiconductor device which has a source electrode, a drain electrode, a gas sensitive film formed of a semiconductor material that changes an electrical characteristic thereof in accordance with an adsorption amount of a gas to be detected, a gate electrode, and a gate insulating film that insulates said gate electrode, said source electrode, and said drain electrode from one another, said semiconductor device being formed on said crystal resonator or said surface acoustic wave device.

9. (canceled)

10. The gas sensor according to claim 8, wherein said gas sensitive film changes an optical-electrical characteristic in accordance with an adsorption amount of said detection target gas.
